(19) United States
(12) Patent Application Publication
(10) Pub. No.: US 2005/0188192 A1
(43) Pub. Date: Aug. 25, 2005

(54) Multiplex re-routing protection process and transmission system for implementing this process

(76) Inventor: Jean-Pierre Vigarie, Cesson Sevigne (FR)

Correspondence Address: ANDERSON, KILL & OLICK, P.C., 1251 AVENUE OF THE AMERICAS, NEW YORK,, NY, 10020-1182, US

(21) Appl. No.: 11/017,303

(22) Filed: Dec. 20, 2004

(30) Foreign Application Priority Data
Dec. 19, 2003 (FR) 03 51129

(51) Int. Cl. H04L 9/00

(52) U.S. Cl. 713/150

(57) ABSTRACT

The invention relates to a process for protecting against the re-routing of a multiplex transmitted by an operator to at least one subscriber, comprising the following stages: on transmission, associating with said multiplex at least one authentication message protected by a cryptographic function susceptible of being generated exclusively by the operator, associating with said message at least one variable data item the evolution of which over time is pre-defined by the operator, and on reception, analysing the authentication message, authorising access to the multiplex if said message is authentic and integral, and if the evolution of the variable data item is coherent, otherwise, prohibiting multiplex access.

### TECHNICAL FIELD

The invention is located in the field of content protection and relates more specifically to a process for protecting against the re-routing of a multiplex transmitted by an operator to at least one receiver terminal.

The invention relates also to a transmission system comprising a transmitter and a receiver adapted to implement the process.

### THE PRIOR ART

In order to protect transmitted contents, operators use access control techniques based on scrambling the transmitted contents by means of secret keys transmitted to subscribers with pre-defined access conditions. On reception, content descrambling is authorised if the access conditions are verified by the receiver terminal.

With these systems, operators can also control the way the transmitted content is used by the receiver terminals. However, these systems do not make it possible to prevent a transmitted multiplex, uncoded or in scrambled form, from being re-routed and being replaced by a pirate multiplex.

FIG. 1a shows diagrammatically the satellite transmission of a multiplex comprising audio-visual programs and the possible fraudulent re-routing of this multiplex. The situation can also be applied to any other transmission system, such as transmission via terrestrial network, or via cable network.

With reference to FIG. 1A, the transmitter 2 transmits to the satellite 4 a multiplex 6 previously scrambled by a cryptographic device 7 and the content of which comprises tables describing the programs, the component parts of the programs and the conditional access data. The satellite 4 transmits the multiplex into the zone of a receiver terminal 8 equipped with a security processor 10.

On transmission, as shown in FIG. 1B, a pirate transmitter 12 may replace the authentic multiplex by a pirate multiplex 16 which will be transmitted by the satellite 4 to the receiver terminal 8 insofar as, at radio frequency level, no modulation/demodulation information allows this substitution to be detected.

In the prior art, the detection of such a substitution by the receiver terminal 8 is based on verifying the conformance of the content of the tables describing the transmitted programs against tables pre-defined by the operator. This conformance can be tested on multiple parameters such as the network identifiers, the value of the packet channel addresses (PID) used, etc. However it is possible with common metrology equipment to enter all these parameters into a real signal and to copy them in order to reconstitute an identical signal making detection of this type inoperative.

Another detection possibility, provided at receiver terminal level by the access control system, consists in verifying the presence and integrity of the entitlement control messages (ECM) associated with the programs. However, such detection is impossible when the operator transmits an uncoded program that does not comprise any ECMs. Additionally, entitlement control messages and the data constituting the tables can easily be recorded in a real signal and then artificially associated with an uncoded pirate program.

The purpose of the invention is to prevent a multiplex from being re-routed during transmission and to prevent this multiplex from being replaced by a pirate multiplex.

### DISCLOSURE OF THE INVENTION

To this end, the invention advocates a process that allows a multiplex replacement to be detected from an analysis of the content of this multiplex.

The process according to the invention comprises the following stages:

On transmission,
associating with the multiplex being transmitted at least one authentication message protected by a cryptographic function susceptible of being generated exclusively by the operator,
associating with said message at least one variable data item the evolution of which over time is pre-defined by the operator,

and on reception,
analysing the authentication message,
authorising access to the multiplex if said message is authentic and integral, and
otherwise, prohibiting multiplex access.

The process according to the invention additionally comprises a stage consisting in verifying the temporal coherence of said variable data item.

In a first embodiment, said authentication message is protected by means of a symmetrical secret key.

In a second embodiment, said authentication message is protected by means of an asymmetrical private key.

In both embodiments, the variable data item may be constituted by the current date or by a counter status.

The process according to the invention applies particularly to a multiplex comprising at least one video component or one audio component encoded according to the MPEG (Moving Picture Experts Group) standard or at least one audio component encoded according to the DAB (Digital Audio Broadcasting) standard. These components may be all or partly scrambled and the authentication message may be integrated with any component, video, audio, or multiplex data. It should be noted that this message may be associated individually with each program of the multiplex or overall with the whole multiplex.

In a first alternative, the authentication message is inserted into a specific private flow dedicated to the authentication function.

In a second alternative, the authentication message is inserted as a private descriptor into a table describing the services carried by the multiplex.

When the multiplex carries audio-visual programs that are all or partly scrambled, the authentication message may be carried by an ECM message associated with a multiplex program, or by an Entitlement Management Message (EMM) associated with the whole multiplex.

It may also be constituted by a data block inserted into a pre-existing ECM message or EMM message.

The multiplex transmission system according to the invention comprises:
a transmitter equipped with means for associating with said multiplex at least one authentication message protected by a cryptographic function and means for associating with said message at least one variable data item the evolution of which over time is pre-defined,
a receiver comprising means for verifying if said message is authentic and integral, and means for verifying the temporal coherence of said variable data item.

The invention also relates to a transmitter comprising means for associating with the transmitted multiplexes at least one authentication message protected by a cryptographic function and means for associating with said message at least one variable data item the evolution of which over time is pre-defined.

Preferentially, said cryptographic function is susceptible of being generated exclusively by the operator.

The receiver according to the invention comprises means for verifying the authenticity and integrity of said message, and means for verifying the temporal coherence of said variable data item.

### BRIEF DESCRIPTION OF THE DRAWINGS

Other characteristics of advantages of the invention will emerge from the following description, given as a non-restrictive example with reference to the appended figures wherein:

FIGS. 1A and 1B previously described show diagrammatically the transmission of a multiplex and the fraudulent re-routing of this multiplex,

FIG. 2 shows a block diagram showing the different modules intended to implement the process according to the invention in a transmission system,

FIG. 3 shows an organisation chart showing the stages in the control of the authenticity of a multiplex by the receiver terminal,

FIG. 4 shows the structure of a multiplex authentication message according to the invention.

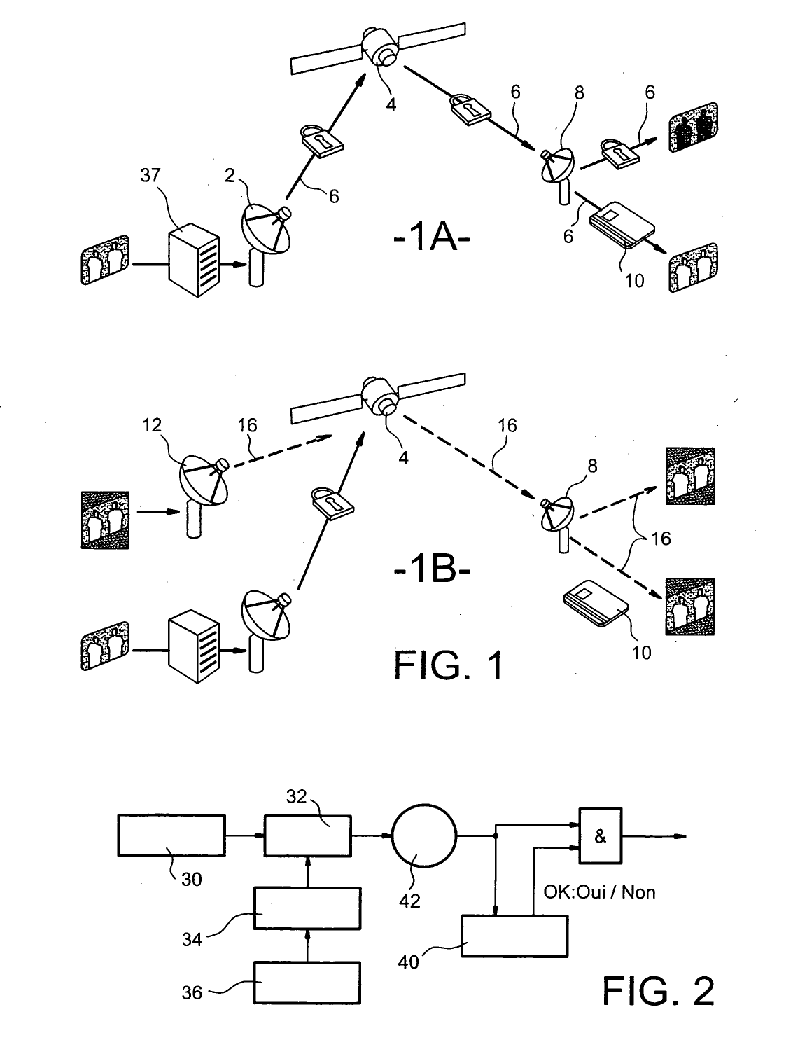

### DETAILED DISCLOSURE OF PARTICULAR EMBODIMENTS

The invention will be described in the context of a transmission of a multiplex comprising a video component encoded according to the MPEG standard or an audio component encoded according to the MPEG standard, fully or partly scrambled.

With reference to FIG. 2, at the transmission end, the system intended to implement the process comprises a scrambling module 30, a multiplexer 32, an authentication message generator 34 and a time-variable data generator 36. Authentication message generation uses cryptographic solutions with keys known solely by the operator. The cryptographic algorithms employed may be with a secret (symmetrical) key or with a public key.

At the reception end the system comprises a calculation module 40 comprising a program for verifying the authentication message and the variable data generated by the generators 34 and 36 respectively.

The audio-visual programs are firstly scrambled fully or partly by the module 30, multiplexed with the authentication message and a variable data item generated by the generators 34 and 36 respectively so as to form a multiplex which will be transmitted via a transmission network 42 to a number of receiver terminals equipped with security processors.

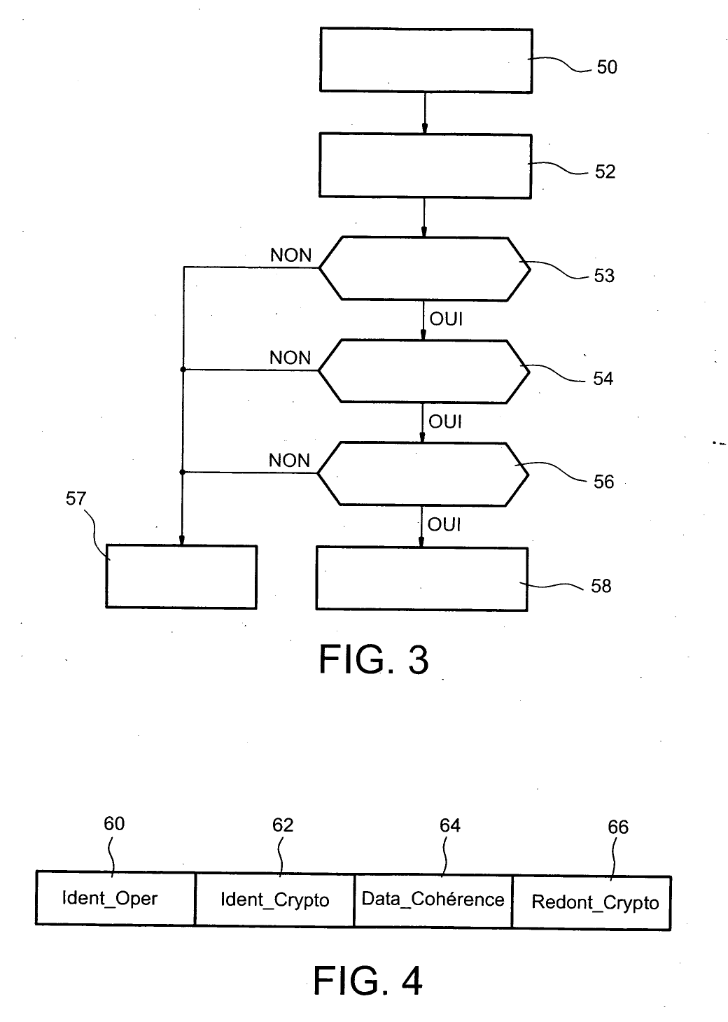

At reception terminal level, the calculation module 40 analyses the multiplex received in accordance with the stages described in FIG. 3 above.

At stage 50, the multiplex is demodulated and demultiplexed, and at stage 52, the authentication message and the variable data item which is associated with it are extracted from the multiplex in order to be analysed.

At stage 53, the presence of the authentication message is verified.

If the authentication message does not exist, the module 40 prohibits access to the multiplex. If the authentication message does exist, the following stage 54 consists in the calculation module 40 verifying the authenticity and integrity of the authentication message by means of the secret keys generated on transmission.

The purpose of this stage is to detect the unauthorised generation of this message.

If the message detected is not authentic, the module 40 prohibits access to the multiplex. If this message is authentic, the following stage 56 consists in verifying the coherence of the associated variable data item.

The purpose of this stage is to detect a fraudulent re-use of the authentication message previously extracted from a operator multiplex and recorded.

Regardless of any other access condition or of the fact that the program is uncoded, access to the program is refused by the terminal equipment (stage 57) if at least one of the conditions in stages 53, 54 and 56 is not verified.

If the authenticity and integrity of the authentication message are verified and if the coherence of the variable data item is also verified, the conventional entitlement control criteria, possibly associated with the multiplex programs are then examined.

FIG. 4 shows diagrammatically the structure of the authentication message. The latter comprises a first field 60 containing the operator identifier (ident_oper), a second field 62 containing the identifier (ident_Crypto) of the cryptographic system used, a third field 64 containing the variable data item (Data_Coherence) used to control the temporal coherence of the variable data item and which may be uncoded or encrypted, and a fourth cryptographic redundancy field 66 (Redond_Crypto) allowing the message authenticity and integrity to be verified. This field may be that of the ECM or EMM message if the authentication message is inserted into one of these ECM and EMM messages.

It should be noted that the structure above comprises no field 60 containing the identifier (ident_oper) when the operator is known implicitly, nor a field 62 containing the cryptographic system identifier (ident-Crypto) when the cryptographic system is known implicitly.

Furthermore, the third field 64 containing the variable data item (Data_Coherence) may be uncoded or encrypted.

1. Process for protecting against the re-routing of a multiplex transmitted by an operator to at least one subscriber, comprising the following stages:
on transmission,
associating with said multiplex at least one authentication message protected by a cryptographic function susceptible of being generated exclusively by the operator,
associating with said message at least one variable data item the evolution of which over time is pre-defined by the operator,
and on reception,
analysing the authentication message,
authorising access to the multiplex if said message is authentic and integral, and
otherwise, prohibiting multiplex access.

2. Process according to claim 1, further comprising the step of verifying the temporal coherence of said variable data item.

3. Process according to claim 1, wherein said authentication message is protected by means of a symmetrical secret key or an asymmetrical private key.

4. Process according to claim 2, characterised in that the variable data item is constituted by the current date.

5. Process according to claim 2, characterised in that the variable data item is constituted by a counter status.

6. Process according to claim 1, characterised in that said multiplex comprises a plurality of audio-visual programs.

7. Process according to claim 6, wherein said programs are all or partly scrambled.

8. Process according to claim 7, wherein the authentication message is associated individually with each multiplex program.

9. Process according to claim 7, wherein the authentication message is associated overall with the whole multiplex.

10. Process according to claim 8, wherein the authentication message is inserted into a specific private flow dedicated to the authentication function.

11. Process according to claim 9, wherein the authentication message is inserted into a specific private flow dedicated to the authentication function.

12. Process according to claim 8, wherein the authentication message is inserted as a private descriptor into a table describing the services carried by the multiplex.

13. Process according to claim 9, wherein the authentication message is inserted as a private descriptor into a table describing the services carried by the multiplex.

14. Process according to claim 8, wherein the multiplex comprises at least one MPEG video component or one MPEG audio component.

15. Process according to claim 9, wherein the multiplex comprises at least one MPEG video component or one MPEG audio component.

16. Process according to claim 8, wherein the multiplex comprises at least one DAB audio component.

17. Process according to claim 9, wherein the multiplex comprises at least one DAB audio component.

18. Process according to claim 12, wherein the authentication message is integrated with any component, video, audio, of the multiplex.

19. Process according to claim 13, wherein the authentication message is integrated with any component, video, audio, of the multiplex.

20. Process according to claim 8, wherein the authentication message is constituted by an ECM message associated with a multiplex program.

21. Process according to claim 9, wherein the authentication message is constituted by an ECM message associated with a multiplex program.

22. Process according to claim 9, wherein the authentication message is constituted by an EMM message associated with the whole multiplex.

23. Process according to claim 8, wherein the authentication message is constituted by a data block inserted into a pre-existing ECM message or EMM message.

24. Process according to claim 9, wherein the authentication message is constituted by a data block inserted into a pre-existing ECM message or EMM message.

25. Multiplex transmission system comprising:
a transmitter equipped with means for associating with said multiplex at least one authentication message protected by a cryptographic function and means for associating with said message at least one variable data item the evolution of which over time is pre-defined,
a receiver comprising means for verifying if said message is authentic and integral, and
means for verifying the temporal coherence of said variable data item.

26. Multiplex transmitter, comprising:
means for associating with the multiplexes at least one authentication message protected by a cryptographic function and means for associating with said message at least one variable data item the evolution of which over time is pre-defined.

27. Transmitter according to claim 26, wherein said cryptographic function is susceptible of being generated exclusively by the operator.

28. Multiplex receiver with which is associated an authentication message against re-routing containing a time-variable data item, characterised in that it comprises means for verifying the authenticity and integrity of said message, and means for verifying the temporal coherence of said variable data item.

29. Message for authenticating a multiplex transmitted by an operator, characterised in that it comprises:
a third field (64) containing a variable data item Data_Coherence used to control the coherence of the multiplex data, and
a fourth cryptographic redundancy field (66) Redond_Crypto allowing the authenticity and integrity of said message to be verified.

30. Message according to claim 29, characterised in that it additionally comprises:
a first field (60) containing the operator identifier ident_oper,
a second field (62) containing a cryptographic system identifier ident_Crypto.
